(19) United States
(12) Patent Application Publication
(10) Pub. No.: US 2014/0025539 A1
(43) Pub. Date: Jan. 23, 2014

(54) ADJUSTABLE PRIORITY RETAILER RANKING SYSTEM

(71) Applicant: Modified Systems, LLC, La Quinta, CA (US)

(72) Inventor: Nils Forsblom, La Quinta, CA (US)

(73) Assignee: Modified Systems, LLC, La Quinta, CA (US)

(21) Appl. No.: 14/037,859

(22) Filed: Sep. 26, 2013

Related U.S. Application Data
(63) Continuation of application No. 12/953,917, filed on Nov. 24, 2010, now abandoned.

(51) Int. Cl. G06Q 30/06

(52) U.S. Cl. CPC G06Q 30/0625
USPC 705/26.62

(57) ABSTRACT

An adjustable priority retailer ranking system that performs a method for generating an ordered comparison list of merchant sources is disclosed. A first unordered list of merchant sources is received from a queried search engine. A location value of an end user is derived. For the merchant sources in the unordered list, a plurality user independent merchant evaluation factors are retrieved, and a plurality of user-independent merchant evaluation factors are generated based upon the location value. Predetermined weights are assigned to the merchant evaluation factors. A merchant ranking score for the merchant sources are generated from a composite of the weights and the merchant evaluation factors. An ordered list of merchant sources arranged according to the ranking scores is outputted to the end user.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to online commerce and processing search results therefor. More particularly, the present disclosure relates to an adjustable priority online retailer ranking system.

2. Related Art

Online shopping for good and services, otherwise referred to as e-commerce, is one of the most common uses for the Internet due to its convenience, ready availability of information for decision-making, lower prices, and a greater selection. In general, customers visit various merchants' websites using a personal computer having a connection to the Internet as well as a web browser application. The merchant websites have visual representations of the products and/or services being sold, along with descriptions of the same. The visual appearance and interactive features are designed to mimic, as closely as possible, actual the experience of shopping in a physical stores. After selecting the desired goods and recording the same into a “shopping cart,” the customer exchanges payment information with the merchant website. Upon successful payment processing, the merchant delivers the ordered product(s).

There are numerous approaches to e-commerce currently being practiced, with each filling a particular need for its respective market sub-segment. One common model is the general retailer that sells a variety of products from different market categories, from books, video games, electronics, household products, sporting goods, and so forth. These types of online retailers include Amazon.com, Walmart.com, Target.com, and so forth. Customers search on and browse the specific retailer's catalog of stocked items, and can expect a consistent user experience along with a selection of relatively wide range of competing products. A market category narrower than general consumer products may be served by specialist retailers, such as selling related products for fashion, photography, aftermarket vehicle accessories, outdoor gear, electronics, computers, and so forth. Because the focus is narrower, a wider range of related or competing products may be offered because such retailers do not have to maintain the breadth of entirely different categories of products. At a further level of specificity, individual manufacturers, brands, or exclusive retailers may also have an online shopping site in which only the products produced thereby are sold. The entire range of products sold or manufactured may be offered, even repair parts and accessories that would otherwise not be stocked by third party resellers.

Customers are oftentimes overwhelmed, however, with the large number of available online shopping and retailer options. As an initial matter, the shopper must determine the online store on which to initiate the search. In most cases, the aforementioned general consumer products retailer, or a well-known or popular specialist retailer, may be a starting point. For those lacking the desire to consider other purchasing options, the product may be purchased immediately without further searching.

For those desiring to compare pricing and other options, the customer may continue the search using a general-purpose search engine such as Google®, Yahoo!®, and the like. Although earlier implementations merely outputted search results including a link to the pertinent page and contextual information, conventional search engines are capable of generating results in a narrowed category of online stores and outputting relevant information for shopping, including price, availability, etc. For example, searching for a particular brand of camcorder may yield a listing of available purchase options from many different retailers (irrespective of the type of retailer). The search results may be organized in accordance with price, though in some cases, the results may be organized by the retailers' ratings by an aggregate of users or other like metrics.

The price offered by a retailer, or user ratings therefor, do not necessarily make that particular option the best for a customer. In most cases, the advertised price does not include shipping and handling costs, which are generally not known until the checkout process has completed. Furthermore, with international transactions, additional costs such as duties and brokerage fees may also be unknown. In aggregating the purchase options, the stocking status, shipping time, and the descriptiveness of the listing may not be immediately apparent from the search engine results page. Thus, although the enhanced search engine results provide a good initial picture of purchasing options, in order to compare the retailers on a more complete basis, it is necessary to navigate to each retailer's product page for the aforementioned information. Accordingly, there is a need in the art for an adjustable priority retailer ranking system.

### BRIEF SUMMARY

In accordance with one embodiment of the present disclosure, a method for generating an ordered comparison list of merchant sources from a query for a product is contemplated. The method may include receiving a first unordered list of merchant sources generated by a search engine in response to the search query thereto for the product. This search query may be initiated by an end user. The method may also include deriving a location value for the end user. Additionally, there may be a step of retrieving values of a plurality of user-independent merchant evaluation factors for each of the merchant sources in the first unordered list. Thereafter, the method may continue with generating values of a plurality of user-dependent merchant evaluation factors for each of the merchant sources in the first unordered list. The values of the user-dependent merchant evaluation factors may be based upon the derived location value for the end user. There may also be a step of assigning predetermined weights to each of the plurality of user-independent merchant evaluation factors and user-dependent merchant evaluation factors. The method may further include generating a merchant ranking score for each of the merchant sources in the first unordered list from a composite of the predetermined weights and the respective user-dependent and user-independent merchant evaluation factors. Furthermore, the method may include outputting to the end user an ordered list of merchant sources arranged according to the generated merchant ranking score associated with the respective merchant sources. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an electronic commerce (E-commerce) environment in which one embodiment of the present disclosure may be implemented;

FIG. 2 is a table illustrating an exemplary product listing;

FIG. 3 is a flowchart describing a method for generating an ordered comparison list of merchant sources from a query for a product;

FIG. 4 is a data flow diagram of the information exchanged between a client computer, a search engine, and a retailer ranking system in the contemplated method detailed in the flowchart of FIG. 3;

FIG. 5 is a block diagram illustrating a set of user-independent factors and user-dependent factors utilized in the method for generating the ordered comparison list of merchant sources;

FIG. 6 is a table of example values for the user-independent factors and user-dependent factors;

FIG. 7 is an exemplary user interface for setting the weights of the user independent factors and the user-dependent factors;

FIG. 8 is a table of example values for the weights of the user-independent factors and the user-dependent factors as set through the exemplary user interface of FIG. 7; and

FIG. 9 is a table of example values of merchant ranking scores of a composite of the weights shown in FIG. 8 and the user-independent factors and the user-dependent factors shown in FIG. 6.

Common reference numerals are used throughout the drawings and the detailed description to indicate the same elements.

### DETAILED DESCRIPTION

Various embodiments of the present disclosure contemplate adjustable priority retailer ranking systems and broadly, related methods for generating an ordered comparison list of merchant sources from a query for a product. It is intended that a user searching for a particular product is provided with information that is organized for easily determining the best possible purchase opportunity that is not necessarily based entirely upon price alone. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

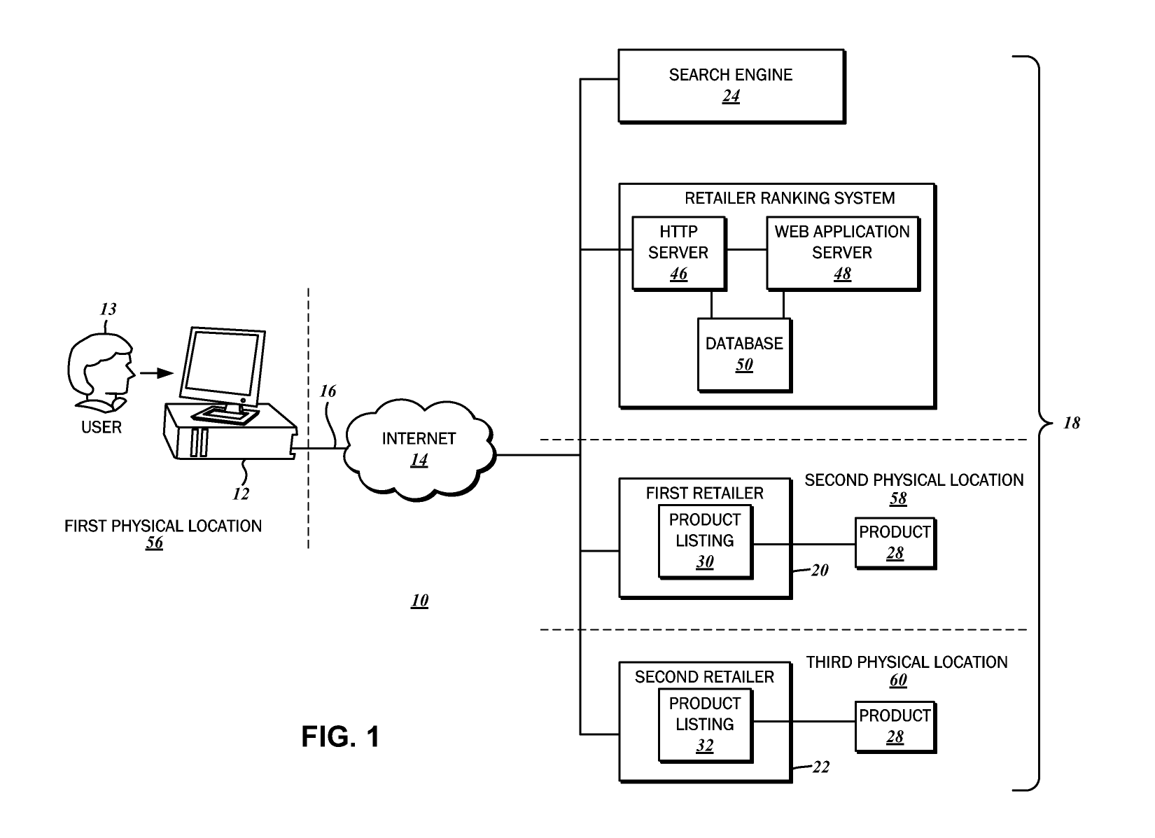

As shown in the block diagram of FIG. 1, the various contemplated methods of the present disclosure may be implemented in an electronic commerce (E-commerce) environment 10. It is to be understood that while specific components thereof are described, any other appropriate component may be substituted. One component of the E-commerce environment 10 is a client computer 12 operated by a user or customer 13. The client computer 12 may be a conventional computer system including a central processing unit, memory, and multiple input and output devices such as keyboards, mice, and display units. Different variations of the computer system including desktop computers, laptop computers, tablet devices, smart phones and the like may be utilized. Any such client computer 12 is configured to be connectible to the global Internet 14 via a connection 16. Additionally, executable instructions of a web browser application are loaded on the client computer 12. It is understood that the web browser application communicates with various web servers 18 over the hypertext transfer protocol (HTTP) to request and receive data.

Among others, the web servers 18 include a first retailer site 20, a second retailer site 22, and a search engine 24, in addition to a retailer ranking system 26 on which various embodiments of the presently contemplated methods may be implemented. As will be recognized by those having ordinary skill in the art, the search engine 24 crawls the various web servers 18 connected to the Internet 14 to parse its contents and index the same for subsequent retrieval. By way of example, the first retailer site 20 makes a product 28 available for purchase by the customer 13, and has a first product listing 30. The second retailer site 20 also makes the same product 28 available for purchase, and has a second product listing 32. Other retailer sites may exist that sell the same product 28, and have respective product listings, but for the sake of brevity, product listing pages and links thereto for other such retailers will not be depicted. The retailer sites may be generally referred to as merchant sources.

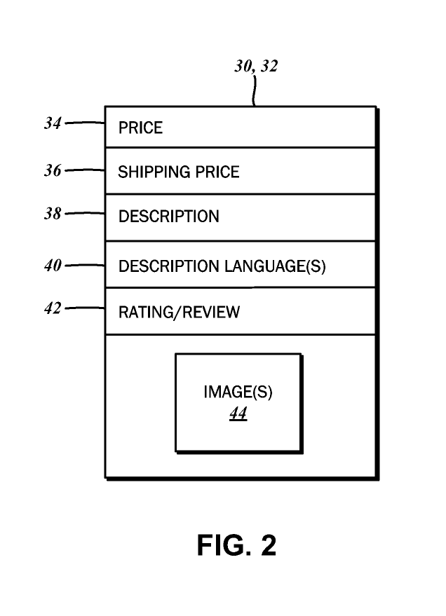

With reference to the table of FIG. 2, the product listings 30, 32 may include a price 34 of the product 28, and a shipping price or set of prices 36. Additionally, detailed information pertaining to the product 28, include a description 38, a description language identifier 40, user ratings and reviews 42, and one or more images 44 may be included. It will be appreciated that this inventory of detailed information is not intended to be exclusive, and other data may be included. The content of the product listings 30, 32 is understood to be indexed by the search engine 24, for linking to the respective first retailer site 20 and the second retailer site 22 as part of a search query result. That is, when the customer 13 enters a query for the search engine 24 for the product 28, a result page including links to the product listings 30, 32 is generated. Upon selection of the links by the customer 13, the client computer 12 establishes a data communications link with the first retailer site 20 and the second retailer site 22 in the manner described above to retrieve the product listings 30, 32, respectively.

The retailer ranking system 26 is shown as an independent server connected to the Internet 14, and like the other servers 18, is accessible by the client computer 12 with a web browser application. In this regard, the retailer ranking system 26 is understood to be a computer system also including a central processor, a memory, input/output devices, and a network connection device, and has software instructions loaded thereon that, when executed, perform various functions of the contemplated methods of the present disclosure. According to one embodiment, the retailer ranking system 26 includes a HTTP server 46, as well as a web application server 48 that executes the functionality of the methods. Additionally there is a database 50 that stores the additional data pertaining to the retailer sites 20, 22 as well as the customer 13, as will be described in greater detail below. There are numerous ways in which an Internet server computer such as those appropriate for the retailer ranking system 26 can be configured using a different commercial, off-the-shelf hardware and software components, and such specifics can be readily ascertained by those having ordinary skill in the art.

In one contemplated embodiment, the retailer ranking system 26 is independent of the search engine 24. However, as will become apparent from the description of its functionality below, incorporating it into the search engine 24 is also envisioned. Thus, the particular arrangement and organization of the retailer ranking system 26, as well as the other web servers 18 connected to the Internet 14, are presented by way of example only and not of limitation.

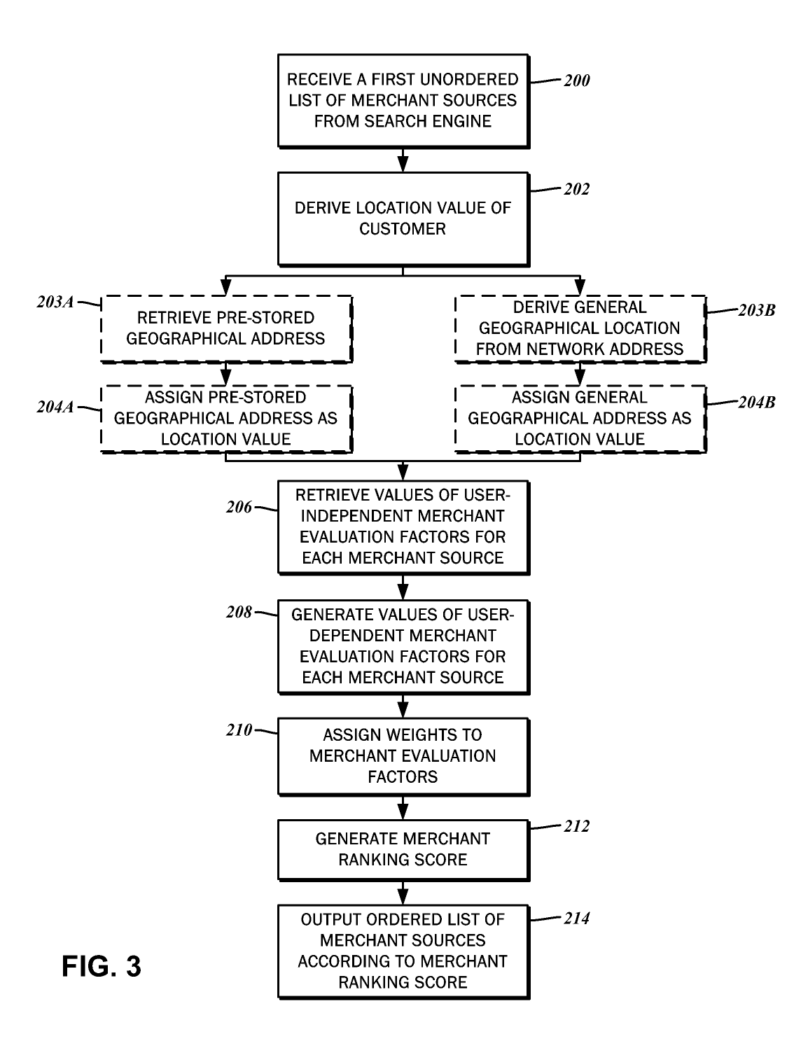

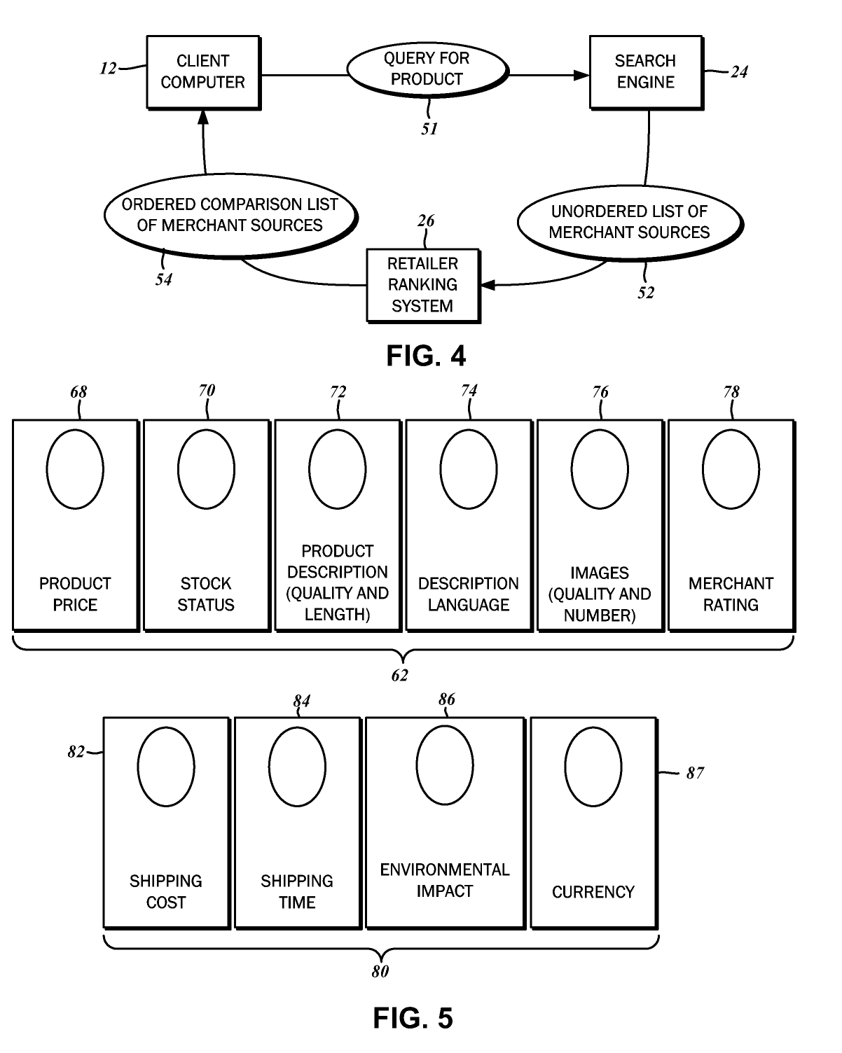

Referring now to the flowchart of FIG. 3 and the data flow diagram of FIG. 4, the method for generating an ordered comparison list of merchant sources 54 begins with a step 200 of receiving a first unordered list of merchant sources 52 generated by the search engine 24. Prior to this step, there may be a preliminary step of receiving, by the search engine 24, a query 51 for the product 28 that is provided by the client computer 12 as entered by the customer 13 in the manner previously described. The first unordered list of merchant sources 52 is understood to be the search engine results page that includes some or all of the information of the product listings 30, 32 set forth above, as well as links to the retailer sites 20, 22, respectively.

Next, the method continues with a step 202 of deriving a location value for the customer 13. As best illustrated in FIG. 1, the customer 13, and likewise the client computer 12, is in a first physical location 56, while the first retailer site 20 may be in a second physical location 58, and the second retailer site 22 may be in a third physical location 60. The pertinence of the physical location of these entities will become more apparent below. In accordance with one embodiment of the contemplated method, the step 200 is understood to include a substep 203A of retrieving a pre-stored geographical address of the customer 13 from an associated account. In further detail, the retailer ranking system 26 can be configured to maintain user account identities in which various customer preferences and information can be stored. Amongst the customer information recorded is a physical address including a street number, street name, city name, zip code, state, and country. This information, which may be amongst the data stored in the database 50, is then assigned to the location value per step 204A. Alternatively, where there is no account identity corresponding to the customer 13, a general geographical location is derived from a network address associated with the client computer 12 per step 203B. It will be appreciated that network nodes connecting to the Internet 14 have a unique network associated therewith that are assigned based on country and region. The network address can be further correlated to a specific Internet Service Provider (ISP) and the particular city or other locale to which a block of addresses for that ISP correspond. Although a specific physical address may not be ascertained, for the purposes of determining shipment parameters as utilized in the presently disclosed method, this is deemed to be sufficient. The derived general geographical location is assigned as the location value in accordance with a step 204B.

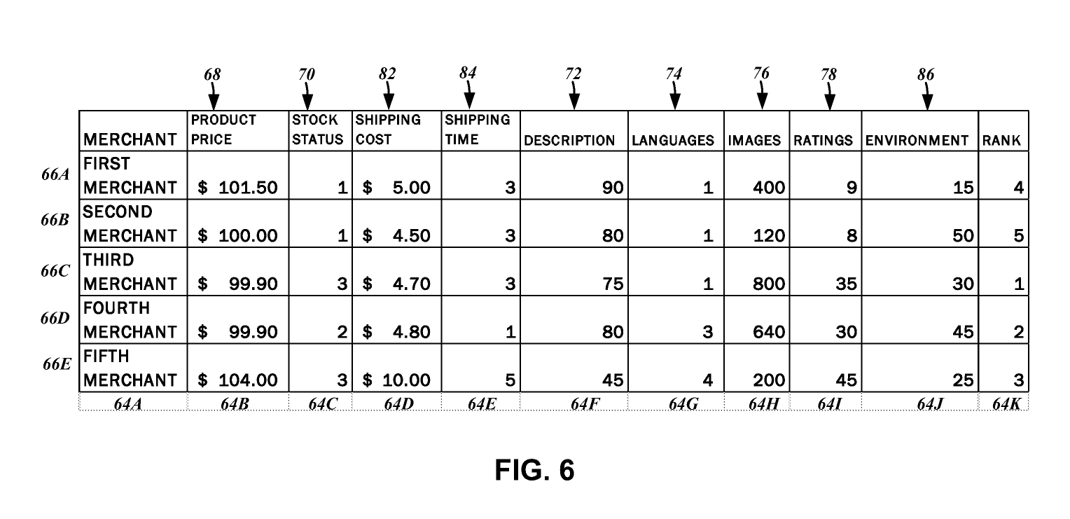

Referring again to the flowchart of FIG. 3, as well as the block diagram of FIG. 5, the method for generating the ordered comparison list of merchant sources 54 continues with a step 206 of retrieving values of a plurality of user-independent merchant evaluation factors 62 for each of the merchant sources. These values may be retrieved from the first unordered list of merchant sources 52 as generated by the search engine 24. Additionally, these values may be retrieved directly from the product listings 30, 32 on the respective first retailer site 20 and the second retailer site 22. In some cases, it may be necessary to do so because of its omission from the first unordered list of merchant sources 52. FIG. 6 depicts an exemplary table that includes, among other items, the values that the user-independent merchant evaluation factors 62 may take. The table has columns 64A-64K, with column 64A indentifying the merchant source to which that particular one of the rows 66A-66E pertains. Thus, each row 66 includes, in separate columns 64A-64K, the evaluation factors for a given merchant source. In the example shown, there is a first merchant source in row 66A, a second merchant source in row 66B, a third merchant source in row 66C, a fourth merchant source in row 66D, and a fifth merchant source in row 66E.

The user-independent merchant evaluation factors 62 are referred to as such because the values are not dependent on the location of the client computer 12. Specifically, these factors include a product price 68 that is shown in column 64B as monetary values in United States (dollars) currency. However, it is understood that any other currency value may be utilized to represent the product price 68. A stock status 70 is understood to indicate whether the desired product 28 is ready for fulfillment. As shown in column 64C, this may take a value of one (1), two (2), or three (3), representative of the product 28 being out of stock and not back-ordered, out of stock but back-ordered, and in stock, respectively. Any other status may be similarly indicated as a numerical value in order of increasing desirability, with the highest desirability, that is, in stock, being the highest number, and the lowest desirability, that is, out of stock without any future likelihood of re-stocking, being the lowest number.

The quality of the product listing may also be ranked by merchant source. In further detail, there is a description qualitative rating 72, which is a numerical score based upon an analysis of the contents of the description 38. Several algorithms therefor are known, and may be implemented by those having ordinary skill in the art. The example table of FIG. 6 shows, in column 64F, a number which can range between 0 and 100. The description qualitative rating 68 may also be determined from the length of the description 38. There is also a description language rating 74 that counts the number of different languages in which the description 38 is available, with higher values contributing to a higher overall score. The description is in most cases one aspect of the product listing, and there is also an image qualitative rating 76. According to one embodiment, the image qualitative rating 76 is a mean file size of every image that is a part of the product listing, as shown in column 64H. A larger file size generally is understood to indicate a higher quality image. Other metrics for the image qualitative rating 76 are also possible, such as total file size of every image that is a part of the product listing, the average pixel dimensions of the images, and so forth, and the example shown in the table of FIG. 6 is not intended to be limiting.

The quality and/or reputation of the merchant source in general may also be factored in accordance with various embodiments of the contemplated methods, and can be so retrieved in step 206. In particular, a merchant rating 78 is retrieved; if this value is not provided as part of the unordered list of merchant sources 52 from the search engine 24, it may be possible for the retailer ranking system 26 to maintain its own records of the same in the database 50. These ratings may be aggregated from a various third party providers. Column 641 shows numerical values assigned to the merchant rating 78 ranging between nine (9) and forty five (45), though again, this is by way of example only and not limitation.

The method continues with a step 208 of generating values of a plurality of user-dependent merchant evaluation factors 80 for each of the merchant sources in the first unordered list 52. It is contemplated that the user-dependent merchant evaluation factors 80 are based upon the derived location value of the customer 13 noted above. The user-dependent merchant evaluation factors 80 may be generated by the retailer ranking system 26 because without the specific location value associated with the customer 13, it may not be available from the search engine 24 or the various retailer sites. With further particularity, the user-dependent merchant evaluation factors 80 include a shipping cost 82. Although some carriers have flat-rate shipping, in most cases the cost of delivery is dependent upon the distance between the customer's first physical location 56 and the facility of the merchant at which the product 28 is stored and shipped. Similarly, the time for delivery is likewise dependent upon this distance, and so another one of the user-dependent merchant evaluation factors 80 is a shipping time 84. As shown in the table of FIG. 6, the shipping cost 82 is given as a monetary value in column 64D, while the shipping time 84 is given as the number of days estimated in column 64E. Furthermore, another user-dependent merchant evaluation factor 80 that relates to the distance between the customer 13 and the merchants is an environmental impact value 86, shown in column 64J. This can include the volume of carbon dioxide emissions, in grams or kilograms, for a given shipment distance and modality, though any other metric relating to environmental concerns may also be utilized. Though not necessarily related to the specific distance between the customer 13 and merchant sources, another user-dependent merchant evaluation factor 80 is a currency value 87 that indicates which currency or how many different currencies that retailer will accept as payment. The customer 13 may have a preferred currency that is set in the account established with the retailer ranking system 26, with those retailers willing to accept that currency achieving a higher numerical value. Again, the foregoing user-dependent merchant evaluation factors 80 are presented by way of example only and not of limitation.

While the various user-independent merchant evaluation factors 62 and user-dependent merchant evaluation factors 80 have been enumerated above, it will be appreciated by those having ordinary skill in the art that such an enumeration is not exclusive, and other factors that would further assist the customer 13 in deciding from which retailer to purchase, may also be incorporated.

Referring again to the flowchart of FIG. 3, the method continues with a step 210 of assigning predetermined weights to each of the user-independent merchant evaluation factors 62 and the user-dependent merchant evaluation factors 80. It is contemplated that these merchant evaluations can be given a different level of importance to the customer 13 in ascertaining the overall merits of each merchant source; for example, price may be given greater weight over shipping time, and so forth. According to one embodiment, the weights are a numerical value between 1 and 5, where 1 is not at all significant, and 5 is very significant. A neutral default value of 3 may be set before any changes are made by the customer 13. Otherwise, the weights may be saved along with account data for the specific customer 13 for subsequent retrieval.

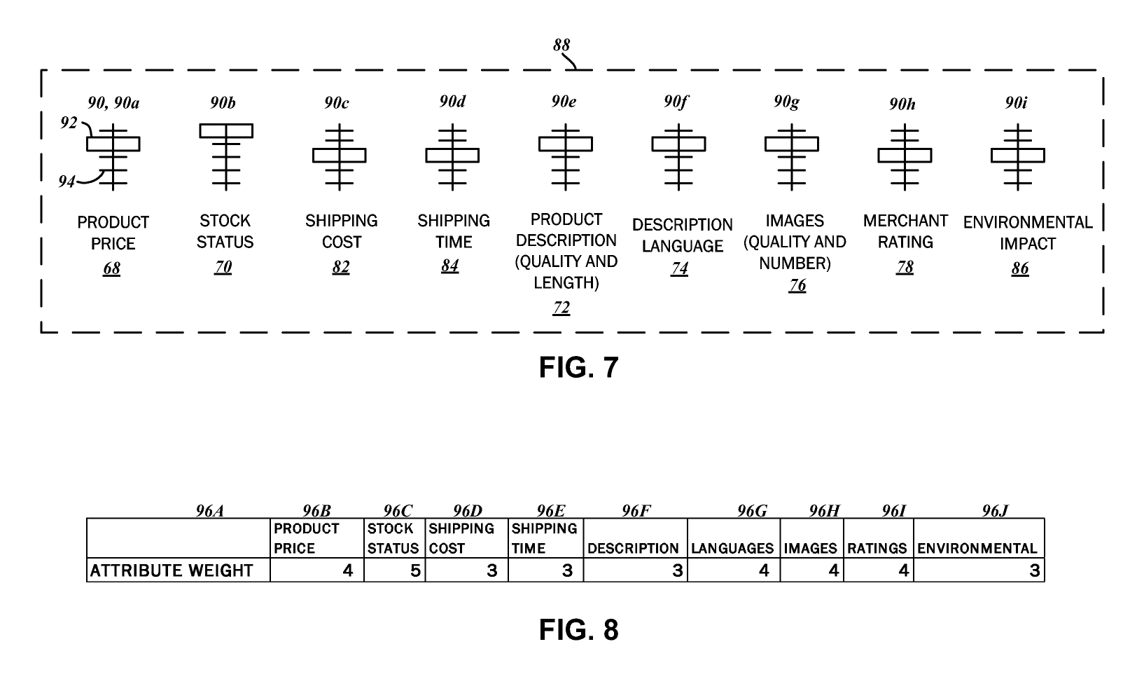

As best illustrated in FIG. 7, the weights are set by the customer 13 via an interface 88 that has a plurality of selector elements 90a-i associated with each of the user-independent merchant evaluation factors 62 and the user-dependent merchant evaluation factors 80. Each includes a slider bar 92 that can be positioned along an incremental scale 94 to set a corresponding weight for that merchant evaluation factor. As further illustrated in the table of FIG. 8, a second column 96B set the weight for product price 68 via the selector element 90a. In this example, the slider bar 92, and hence the value, is set to 4. A third column 96C indicates that the weight is set to 5 for the stock status 70 via the selector element 90b. A fourth column 96D indicates that the weight for the shipping cost 82 is set to 3 with the selector element 90c. The shipping time 84 is set to 3 as shown in fifth column 96E and selector element 90d. The weight of the description qualitative rating 72, which is set by the selector element 90e, is 4 as shown in sixth column 96F. The weight of the description language rating 74 is set by the selector element 90f to indicate a 4, as shown in corresponding seventh column 96G. The image qualitative rating 76 has a weight of 4 as shown in the selector element 90g and column 96H of the table, and the merchant rating 78 has a weight of 3 per the selector element 90h and column 96I. Finally, the weight of the environmental impact rating 86 is set to 3 via the selector element 90i, and recorded as such in column 96J.

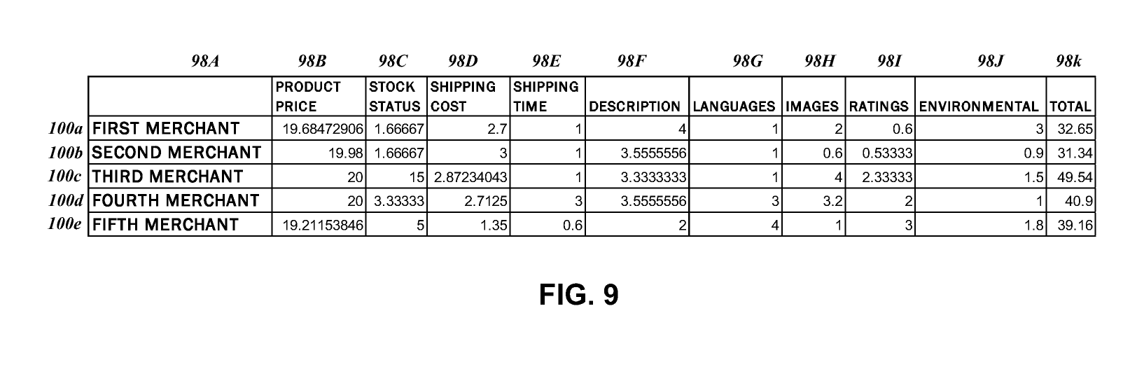

Returning to the flowchart of FIG. 3, the method continues with a step 212 of generating merchant ranking scores for each of the merchant sources in the first unordered list 52. Listed in the table of FIG. 9, in column 98L, are the total merchant ranking scores, which are generally a composite of the weights discussed in relation to FIG. 8, the user-independent merchant evaluation factors 62, and the user-dependent merchant evaluation factors 80. In one contemplated modality for generating the merchant ranking scores, each of the merchant evaluation factors 62, 80 are multiplied by the weight corresponding thereto, and divided by the highest value amongst all of the merchants in that evaluation factor. For example, the merchant ranking score for the product price 68 for the first merchant shown in row 66A of the table of FIG. 6, involves multiplying 4 (the weight) times 101.50 (the product price 68). The product is then divided by 99.90, which is the best price amongst all of the merchant sources in the first unordered list 52. In this regard, it is to be understood that the merchant ranking score of a given one of the merchant sources is relative to the merchant ranking scores of the other merchant sources in the first unordered list 52. This calculation is repeated for each of the rows 100A-100E, as well as for the respective columns 98C-98J. The details of such calculations will not be repeated for the sake of brevity. A total merchant ranking score, as indicated above, is generated from each of the individual merchant ranking scores shown in columns 98B-98J for the respective merchants in rows 100A-100E.

The contemplated method also includes a step 214 of outputting to the customer 13 the ordered comparison list of merchant sources 54, in which the merchants are arranged according to the total merchant ranking scores discussed above. The ordered comparison list of merchant sources 54 is envisioned to provide the customer 13 with an improved shopping experience, as the best purchase opportunity, per the different importance placed on different factors, is presented in order. Hence, the priority of the ranking of merchants is adjustable according to various aspects of the present disclosure. Furthermore, the pricing, particularly as it relates to shipping, is understood to be more transparent. In accordance with one embodiment of the present disclosure, the ordered comparison list of merchant sources 54 is a HyperText Markup Language (HTML) formatted page that is rendered by the browser application executing on the client computer 12, and links to the merchants or retailer sites is provided.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for generating an ordered comparison list of merchant sources from a query for a product, the method comprising:
receiving a first unordered list of merchant sources generated by a search engine in response to the search query thereto for the product, the search query being initiated by an end user;
deriving a location value for the end user;
retrieving values of a plurality of user-independent merchant evaluation factors for each of the merchant sources in the first unordered list;
generating values of a plurality of user-dependent merchant evaluation factors for each of the merchant sources in the first unordered list based upon the derived location value for the end user;
assigning predetermined weights to each of the plurality of user-independent merchant evaluation factors and user-dependent merchant evaluation factors;
generating a merchant ranking score for each of the merchant sources in the first unordered list from a composite of the predetermined weights and the respective user-independent merchant evaluation factors and user-dependent merchant evaluation factors; and
outputting to the end user an ordered list of merchant sources arranged according to the generated merchant ranking score associated with the respective merchant sources.

2. The method of claim 1, wherein a one of the plurality of user-independent merchant evaluation factors is selected from a group consisting of: a price of the queried product, a stock status of the queried product, a description qualitative rating, a description language rating, an image qualitative rating, and a merchant rating value.

3. The method of claim 2, wherein the description qualitative rating for a given one of the merchant sources is generated by a scoring system analyzing the content of a description associated with the queried item as provided by the given one of the merchant sources.

4. The method of claim 2, wherein the description language rating for a given one of the merchant sources corresponds to the number of different languages in which a description associated with the queried item by the given one of the merchant sources is provided.

5. The method of claim 2, wherein the image qualitative rating for a given one of the merchant sources corresponds to an average file size in which images associated with the queried item by the given one of the merchant sources is provided.

6. The method of claim 1, wherein a one of the plurality of user-dependent merchant evaluation factors is selected from a group consisting of: a shipping cost for the queried product, a shipping time for the queried product, an environmental impact value associated with shipping the queried product, and a currency value.

7. The method of claim 1, wherein the step of deriving the location value for the end user further includes:
retrieving a pre-stored geographical address from an account associated with the end user; and
assigning the pre-stored geographical address as the location value.

8. The method of claim 1, wherein the step of deriving the location value for the end user further includes:
deriving a general geographic location from a network address associated with the end user; and
assigning the general geographic location as the location value.

9. The method of claim 1, wherein the merchant ranking score of a given one of the merchant sources is relative to the merchant ranking scores of the other merchant sources in the first unordered list.

10. The method of claim 1, wherein the predetermined weights are set by the end user with an interface including an display of each of the user-independent merchant evaluation factors and user-dependent merchant evaluation factors with an interface element for quantifying the relative importance to the end user along a scale.

11. The method of claim 10, wherein the quantified relative importance to the end user is a numerical value between one and five.

12. The method of claim 10, wherein the predetermined weights are assigned default values.

13. The method of claim 1, wherein the ordered list of merchant sources is generated as a web page rendered by a browser application.

14. An article of manufacture comprising a program storage medium readable by a computer, the medium tangibly embodying one or more programs of instructions executable by the computer to perform a method for generating an ordered comparison list of merchant sources from a search query for a product, the method comprising:
receiving a first unordered list of merchant sources generated by a search engine in response to the search query thereto for the product, the search query being initiated by an end user;
deriving a location value for the end user;
retrieving values of a plurality of user-independent merchant evaluation factors for each of the merchant sources in the first unordered list;
generating values of a plurality of user-dependent merchant evaluation factors for each of the merchant sources in the first unordered list based upon the derived location value for the end user;
assigning predetermined weights to each of the plurality of user-independent merchant evaluation factors and user-dependent merchant evaluation factors;
generating a merchant ranking value for each of the merchant sources in the first unordered list from a composite of the predetermined weights and the respective user-dependent merchant evaluation factors and user-independent merchant evaluation factors; and
outputting to the end user an ordered list of merchant sources arranged according to the generated merchant ranking value associated with the respective merchant sources.
